(19) United States
(12) Patent Application Publication
(10) Pub. No.: US 2003/0111502 A1
(43) Pub. Date: Jun. 19, 2003

(54) Bicycle transport rack

(76) Inventor: Jack G. DuPlantis, Beaumont, TX (US)

Correspondence Address: Valerie Friedrich, 1422 Chestnut Springs, Houston, TX, 77062, US

(21) Appl. No.: 10/017,424

(22) Filed: Dec. 18, 2001

(51) Int. Cl. B60R 9/00; B60R 11/00

(52) U.S. Cl. 224/519; 224/532; 224/924

(57) ABSTRACT

A bicycle transport rack for connection to a vehicle hitch and holding one or more bicycles having a hitch connection end and an outwardly extending extender bar from which mounting rod assemblies extend vertically. A bicycle is mounted in an upside down position on the rack by placing the bicycle seat mounting tube over and around the mounting rod assemblies. The bicycle is held onto the mounting rod assembly by lengthwise compression and outward expansion of expandable flanges against the internal surface of the bicycle seat mounting tube.

### FIELD OF THE INVENTION

This invention relates to a bicycle rack for use in transporting one or more bicycles on a vehicle. More specifically, the invention relates to a bicycle rack which may be connected to any vehicle having a towing hitch.

### BACKGROUND OF THE INVENTION

Bicycling is a popular activity across the world, both as a casual pastime and as a professional sport. For both types of activities, a bike may need to be transported some distance to an appropriate riding location, such as to a low traffic highway, race location, a park, or to a wilderness area. A number of bicycle racks are currently available on the market for use to transport bicycles on cars or other types of vehicles. Such racks vary widely in price and the location on which they are attached to the vehicle. Almost all currently available transport racks, however, carry the bicycle in an upright position.

One common type of transport rack attaches to the roof of a vehicle and holds one or more bikes in an upright position. Roof mounted racks currently range in price from about $325 upward and are fairly complicated to assemble. Such racks require the user to lift the bicycle over his or her head and onto the roof of the vehicle. This maneuver can be very difficult for most people with the difficulty increasing with the height of the vehicle. Furthermore, roof mounted racks subject the bikes to damage from low overhangs or restrict a vehicles access in wilderness areas or through low bridges.

Another common type of bike transport rack mounts to the trunk of a vehicle using straps that attach to a metal vehicle component. These types of bike racks are generally the least expensive ranging in price from about $30 and up. The attachment of such trunk mounted racks is often quite complicated and generally results in loss of access to the trunk. Such racks generally hold the bicycle upright along the crossbar of the bike and therefore, the rack must extend upward from the trunk so as to prevent the bicycle tires from dragging on the ground. As a result the bike tends to partially block the view through the rear window of the vehicle.

Yet another type of bike transport rack is a hitch mounted rack. In a manner similar to trunk mounted racks, currently available hitch mounted racks hold the bicycle in an upright position by latching the cross bar of the bike. To prevent the bike from touching the ground, the hitch mounted racks include an upwardly extending vertical bar so as to raise the level of the bike support bar. Such vertical bars are often up to four feet in height thereby greatly increasing both the weight and cost of the rack and making storage of the rack difficult. As with trunk mounted racks, hitch mounted racks cause a partial blockage of view through the rear vehicle window.

In both the trunk and hitch mounted types of racks, the weight of the bicycle is placed on the bicycle cross bar which is not intended as a load bearing component of the bicycle. Consequently, transport of the bike across rough or bumpy terrain could result in damage to the cross bar. Furthermore, such racks may scratch the paint of the bicycle cross bar. In addition, not all types of bicycles can be effectively and safely mounted on such racks as not all bicycles have horizontal cross bars. For example, bicycles for female use and Y-frame bikes do not have a horizontal cross bar. Furthermore, many such prior art racks use two parallel support bars on which the cross bar is laid. Such support bars are often distanced so as to preclude use with child bicycles on which the cross bar is not sufficiently long to reach the distance between the support bars. Other components of the bicycle are also subject to potential scratching or damage as such racks generally mount bicycles fairly close to each other allowing for significant rubbing of the bicycles against each other.

Yet other types of currently available bike transport racks hold the bicycle to the rack using the bicycle front wheel mounting bars. Although such bars are built to bear loads, such mounting racks require the removal of the bicycles front wheel and brake connection. Reassembly of the bicycle after transport on such a rack is time consuming and cumbersome and requires the re-calibration of the brake.

Installation of a bicycle on most prior art racks is difficult, requiring either lifting of the bicycle to a substantial height or removal of critical bicycle components.

There is a need therefore for a bicycle transport rack which carries the bicycle across a load bearing component of the bicycle, does not block the rear view of the vehicle, which does not subject the bicycle to damage from low overhangs and does not require complex reassembly of the bicycle following transport. There is a further need for a bicycle transport rack which is easy to install on a vehicle, is not cumbersome to install or to store, onto which it is easy to load the bicycle, and which does not result in the loss of use of the hitch receiver. Moreover, there is a need for a bicycle transport rack which does not risk scratching the paint of the bicycle or of the vehicle, and which can be used with any type of bicycle including male, female, adult, child, racing, mountain and Y-frame bicycles.

### SUMMARY OF THE INVENTION

The bicycle transport rack of the present invention satisfies the need discussed above. The bicycle rack of the present invention mounts to a vehicle by connection with a vehicle hitch and extends substantially straight outward from the vehicle hitch. The bicycle rack contains one or more mounting rod assemblies, each of which holds a single bicycle in an upside down position by placing the bicycle seat mounting tube over and around the mounting rod assembly. Because the bicycle is held in an upside down position, the transport rack need not extend upwardly from the vehicle hitch and therefore, causes less blockage of the rear view. The bicycle is held onto the mounting rod assembly by expansion of expandable flanges which press against the internal surface of the bicycle seat mounting tubes. Because the bicycle seat mounting tube is a load bearing component of the bicycle, no damage should be incurred to the bicycle by placing the weight of the bicycle on the tube. Furthermore, most modern bicycles have easy hand operated seat connection clamps so that the seat may be easily removed for transport and easily replaced following transport without the use of any tools.

The bicycle rack of the present invention is, in comparison to most prior art devices, lightweight weighing about twenty pounds, and has a relatively low manufacturing cost.

Because the extender bar of the present invention extends substantially horizontally from the vehicle hitch, there is no need to raise the bicycle a substantial height in order to place the bicycle onto the rack. Furthermore, the bicycle transport rack of the present invention easily attaches to the vehicle by sliding the hitch connection end into the vehicle hitch receiver and inserting a hitch pin.

### BRIEF DESCRIPTION OF THE DRAWINGS

FIG. 1 is a plan side view of a first embodiment of the bicycle rack of the present invention.

FIG. 2 is a cross-sectional side view of a second embodiment of the bicycle rack of the present invention.

FIG. 3 is a plan side view of a first embodiment of the bicycle rack of the present invention in use with two bicycles placed onto the rack and as attached to a vehicle.

### DETAILED DESCRIPTION OF THE INVENTION

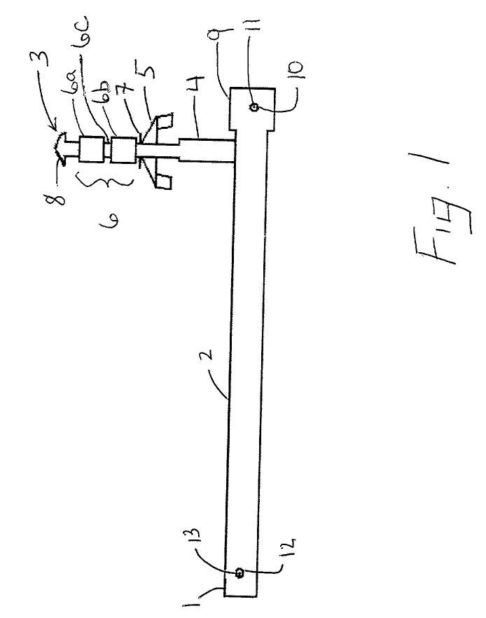

Referring first to FIG. 1 a first embodiment of the bicycle rack of the present invention is shown in which a hitch connector end 1 in a form to fit into a standard vehicle hitch mount which is substantially a 2-inch square and may be either hollow tubing or of solid construction. Hitch connector end 1 is rigidly connected to an extender bar 2 which extends substantially straight out from hitch connector 1. Hitch connector end 1 has a hole 12 extending from one side surface to the other side surface and of about ⅝ inch in diameter so as to receive a standard hitch pin 13. Although hitch connector end 1 must be of a size and shape to fit within a hitch receiver, extender bar 2 may be of any shape including for example a square tube or a circular tube or rod. Extending perpendicularly upward from and rigidly attached to extender bar 2 are one of more mounting rod assemblies 3. Each mounting rod assembly 3 is made of an internal rod 4 which has a larger diameter proximate to extender bar 2 than its diameter at some distance from extender bar 2. The change in diameter of internal rod 4 may be a step change as shown in FIG. 1 or may be a sloping change. The smaller diameter portion of internal rod 4 has external threading so as to receive a wing nut 5. Wing nut 5 may be screwed so as to raise and lower the position of wing nut 5 on internal rod 4. In the preferred embodiment of the invention, a washer 7 is placed onto internal rod 4 above wing nut 5. It will be understood that another type of nut, such as a hexagonal nut, may be used in place of the wing nut 5. A wing nut, however, is used in the preferred embodiment so as to allow ease of use. A flange assembly 6 is threaded onto internal rod 4 above washer 7. Flange assembly 6 may be made of two separate expandable flanges 6a and 6b separated by a bushing 6c, as shown in FIG. 1, or alternatively, a single expandable flange. Preferably, the expandable flanges 6a and 6b of flange assembly 6 are of some crushable material which extends outward causing an increase in diameter upon lengthwise contraction. Such materials include rubber and certain expandable plastic materials. Collet systems and scored metal or plastics collars may also be used as suitable expandable flanges. Bushing 6c is made from a substantially non-compressible material. Washer 7 preferably has an external diameter approximately equal to or greater than the external non-extended diameter of the expandable flanges 6a and 6b. Attached onto internal rod 4 above flange assembly 6 is a top cap 8 having an external diameter equal to or greater than the non-extended external diameter of expandable flanges 6a and 6b. In use, the bicycle seat of a bicycle to be transported is removed from its bicycle seat mounting tube. The bicycle is then turned upside down and the bicycle seat mounting tube is placed over and around the mounting rod assembly 3. Wing nut 5 is turned to move upward along internal rod 4 thereby compressing flange assembly 6 and causing expandable flanges 6a and 6b to expand outwardly and grip the internal surface of the bicycle seat mounting tube. The pressure of the expanded expandable flanges 6a and 6b against the internal surface of the bicycle seat mounting tube holds the bicycle onto the mounting rod assembly 3. In the preferred embodiment of the present invention, a receiver hitch 9 is rigidly attached to extender bar 2 at a position proximate to mounting rod assembly 3. The shape and size of receiver hitch 9 is such as to internally receive a vehicle hitch mount or vehicle hitch light (not shown). Receiver hitch 9 is therefore in the form of a hollow square tube and has a hole 10 of about ⅝ inch diameter on each of its two sides so as to receive a standard mounting pin 11. Top cap 8 is attached to the topmost end of internal rod 4.

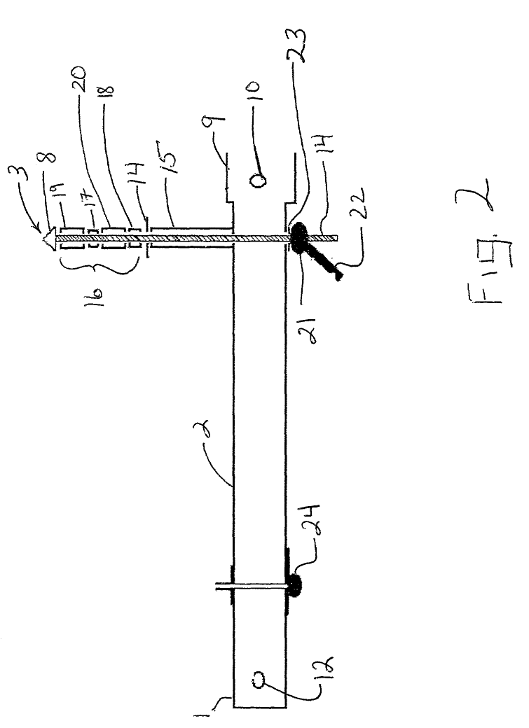

Referring now to FIG. 2, a second preferred embodiment of the bicycle transport rack of the present invention is shown. In the second preferred embodiment, mounting rod assembly 3 is made of an internal threaded bolt 14 passing vertically through extender rod 2. Extending upward from the top surface of extender bar 2, a spacer rod 15 is placed over and around internal threaded bolt 14. Spacer rod 15 may range in length from about 1 inch to about 20 inches. Resting above a top end of spacer rod 15 and around internal threaded bolt 14 is a washer 7. A flange assembly 16 made of two substantially non-compressible bushings 17 and 18 and two expandable flanges 19 and 20 is placed above washer 7 and around internal threaded bolt 14. A cam nut 21 is threaded onto a lower portion of internal threaded bolt 14 below a lower surface of extender rod 2. Expandable flanges 19 and 20 are caused to outwardly expand by turning cam nut 21 so as to cause top cap 8 to lower and press against expandable flanges 20 thereby compressing the entire flange assembly 16 between top cap 8 and washer 7. For the convenience of the user, cam nut 21 has a rigidly attached handle 22 in the preferred embodiment of the invention. For minimization of wear on cam nut 21, a washer 23 may be placed around internal threaded bolt 14 between cam nut 21 and extender bar 2.

Referring still to FIG. 2, an optional feature of the bicycle transport rack of the present invention is shown. Extender bar 2 may be intersected by hinge 24 so as to allow the forward portion of the bicycle transport rack to swing downward so that a back door of the vehicle may be easily opened and accessed.

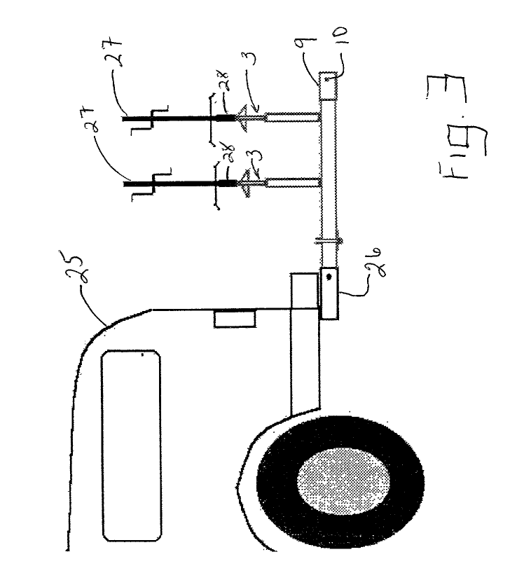

Referring now to FIG. 3, the bicycle transport rack of the present invention is shown in use. A rear portion of a vehicle 25 having a hitch 26 is shown into which the bicycle transport rack of the present invention is attached. Two bicycles 27 are mounted onto mounting rod assembly 3 by placing seat mounting tube 28 over and around mounting rod assembly 3. It can be seen in FIG. 3 that because the bicycle is held in an upside down position extender bar 2 may extend straight out from hitch connection end 1 without resulting in dragging of any part of the bicycle along the road surface.

It will be understood that the diameter of internal rod 4 and threaded internal bolt 14 are less than the standard internal diameter of bicycle seat mounting tubes. The non-expanded outer diameter of the expandable flanges must also be sufficiently small to allow the bicycle seat mounting tube to be easily slipped over and around such rubbers. The expandable flanges must have sufficient expansion upon compression to permit a firm grip to be established on the internal surface of the bicycle seat mounting tube.

The mounting rod assembly may vary in overall height and need extend only a sufficient height to provide firm attachment of the bicycle. Because the bicycle is placed in the upside down position, there is no need for the mounting rod assemblies to raise the bicycle greatly above the extender bar. A typical mounting rod assembly will have an overall height of less than one foot.

Hitch connection end 1, extender bar 2 and receiver hitch 9 should be made from a strong load bearing material. In the preferred embodiment of the invention, such components are made from hollow square tubing of between about 3/16 inch and ¼ inch wall thickness structural steel tubing. Hitch connection end 1 may be constructed to fit within standard 1 ¾ inch or 2 inch hitch receivers or may be custom built to fit within custom hitch receivers.

It will be understood that the bicycle transport rack of the present invention may be made with one or more mounting rod assemblies so as to carry one or more bicycles. For multiple bicycle carriage, mounting rod assemblies should be placed with about twelve inches or greater from each other. The mounting rod assembly closest to the vehicle should be no closer than about twenty-four inches from the forward end of the extender bar so as to prevent any rubbing between the bicycle and the vehicle. It will be understood that the bicycle transport rack of the present invention may be made with several mounting rod assemblies so as to allow the transport of several bicycles. Alternatively, a user may attach one or more of the bicycle transport racks of the present invention together, in a modular manner, to increase the number of bicycles which may be carried. For a two bike carrier, the rack of the present invention would extend about thirty inches from the rear vehicle bumper.

I claim:

1. A bicycle transport rack comprising:
a hitch connector end having a hole for receiving a standard hitch pin;
an extender bar having forward and rearward ends, said forward end rigidly mounted to extending rearward from said hitch connector end; and
one or more mounting rod assemblies extending vertically upward from said extender bar.

2. The bicycle transport rack of claim 1 wherein said rod assembly comprises a rod having an external diameter less than the inside diameter of a bicycle seat mounting tube.

3. The bicycle transport rack of claim 1 wherein said rod assembly comprises:
an internal rod having a lower end proximate to said extender rod, said internal rod having a larger external diameter at said lower end and an externally threaded portion above said lower end;
a wing nut threaded onto said threaded portion proximate to said lower end;
a flange assembly placed around said threaded portion and above said wing nut; and
a top cap attached to a top end of said threaded portion above said flange assembly.

4. The bicycle transport rack of claim 1 further comprising a receiver hitch attached to said rearward end of said extender rod.

5. The bicycle transport rack of claim 1 further comprising a washer threaded onto said threaded portion above said wing nut and below said flange assembly.

6. The bicycle transport rack of claim 1 wherein said flange assembly comprises:
one or more expandable flanges and one or more substantially non-compressible bushings.

7. The bicycle transport rack of claim 6 wherein said expandable flanges are made from rubber.

8. The bicycle transport rack of claim 6 wherein said expandable flanges are made from expandable metal.

9. The bicycle transport rack of claim 6 wherein said expandable flanges are comprised of a collet.

10. The bicycle transport rack of claim 1 further comprising a hinge intersecting said extender bar at or near said forward end of said extender bar, said hinge opening so as to permit said rearward end of said extender bar to swing downward.

11. A bicycle transport rack comprising:
a hitch connector end having a hole for receiving a standard hitch pin;
an extender bar having forward and rearward ends, said forward end rigidly mounted to extending rearward from said hitch connector end;
one or more mounting rod assemblies extending vertically upward from said extender bar, each of said mounting rod assemblies comprising:
an internal threaded bolt having a lower end extending through and below said extender bar;
a spacer rod placed around said internal threaded bolt and rising above said extender bar;
a washer placed around said internal threaded bolt above said spacer rod;
a flange assembly placed around said internal threaded bolt and above said washer;
a top cap attached to a top end of said internal threaded bolt above said flange assembly; and
a cam nut threaded onto said internal threaded bolt below said extender bar.

12. The bicycle transport rack of claim 11 further comprising a receiver hitch attached to said rearward end of said extender rod.

13. The bicycle transport rack of claim 11 wherein said flange assembly comprises:
one or more expandable flanges and one or more substantially non-compressible bushings.

14. The bicycle transport rack of claim 11 further comprising a hinge intersecting said extender bar at or near said forward end of said extender bar, said hinge opening so as to permit said rearward end of said extender bar to swing downward.

15. The bicycle transport rack of claim 11 wherein said cam nut further comprises a handle.

16. The bicycle transport rack of claim 11 further comprising a washer placed around said internal threaded bolt between said cam nut and said extender bar.

17. The bicycle transport rack of claim 11 wherein said spacer rod is about six inches long.

18. The bicycle transport rack of claim 1 wherein said extender bar is a hollow square tubing.

19. The bicycle transport rack of claim 11 wherein said extender bar is a hollow square tubing.

20. The bicycle transport rack of claim 13 wherein said expandable flange is made of rubber.
